(19) United States
(12) Patent Application Publication
(10) Pub. No.: US 2015/0037550 A1
(43) Pub. Date: Feb. 5, 2015

(54) SILVER-CONTAINING AQUEOUS INK FORMULATION FOR PRODUCING ELECTRICALLY CONDUCTIVE STRUCTURES, AND INK JET PRINTING METHOD FOR PRODUCING SUCH ELECTRICALLY CONDUCTIVE STRUCTURES

(71) Applicants: Venkataramanan Balasubramaniam, Singapur (SG); Daniel Rudhardt, Koln (DE); Frank Sicking, Overath (DE); Stefanie Eiden, Leverkusen (DE)

(72) Inventors: Venkataramanan Balasubramaniam, Singapur (SG); Daniel Rudhardt, Koln (DE); Frank Sicking, Overath (DE); Stefanie Eiden, Leverkusen (DE)

(73) Assignee: BAYER TECHNOLOGY SERVICES GMBH, Leverkusen (DE)

(21) Appl. No.: 14/125,756

(22) PCT Filed: Jun. 13, 2012
(86) PCT No.: PCT/EP2012/061157

§ 371 Date: Jun. 9, 2014

(30) Foreign Application Priority Data
Jun. 14, 2011 (DE) 10 2011 077 492.0

(51) Int. Cl. C09D 11/52; H01B 13/00; C08K 3/28; C08K 3/38; C09D 139/06; C09D 11/36

(52) U.S. Cl. CPC C09D 11/52; C09D 139/06; C09D 11/36; C08K 3/28; C08K 3/38; H01B 13/0016; H01B 13/0026
USPC 428/208; 252/519.34; 427/125

(57) ABSTRACT

The present invention relates to a silver-containing aqueous ink formulation for production of electrically conductive structures, wherein the formulation is provided in the form of a two-component system composed of a vehicle component A at least comprising an organic solvent, additives and water, and a silver nanoparticle sol as component B, at least comprising a liquid dispersant, stabilized silver nanoparticles and an electrostatic dispersion stabilizer, and the formulation composed of components A and B comprises at least
a) 1-50% by weight of organic solvent,
b) 0.005-12% by weight of additives, and
c) 40-70% by weight of water,
   and
d) 15-50% by weight of electrostatically stabilized silver nanoparticles,
   where the sum of the total proportions in the ink formulation adds up to 100% by weight in each case. It further relates to a process for producing such ink formulations and to a process for producing electrically conductive structures and/or coatings on a substrate, and to the use of an inventive ink formulation as an ink for inkjet printers and/or for production of electrically conductive structures and coatings.

The present invention relates to a silver-containing aqueous ink composition for production of electrically conductive structures, especially on flexible substrates, especially by inkjet printing methods, wherein this formulation is provided as a one- or two-component system composed of a vehicle component A and a silver nanoparticle sol comprising electrostatically stabilized silver nanoparticles as component B. It further relates to electrically conductive structures obtainable from the inventive printable ink formulation and to the use of the ink formulation as an ink for inkjet printers.

Inkjet printing and other printing methods may be useful as alternative options for the application of functional materials. The advantage of inkjet printing methods is that the printed image, i.e. ultimately the finished structures, can be altered at any time. In screen printing methods, a new mask would first have to be produced. An important field of use relates to that of the printed electronics of conductive structures, especially composed of silver. These have a high electrical conductivity and, at the same time, a reduced propensity to corrosion because of the precious metal character.

In the processing of silver or other metals in a fluid state, there exist two fundamental concepts. Firstly, stabilized nanoparticles can be dispersed in organic solvents or in water. However, it is found that particles have a tendency to block the nozzles in the inkjet printing method when the diameter thereof exceeds about 5% of the nozzle diameter. Furthermore, comparatively high temperatures are required to sinter the stabilized nanoparticles. Such temperatures are not compatible with all substrates.

The second option is the use of a metal ink, i.e. of a solution of a metal-containing molecule or particle in an appropriate solvent. The use of inks filled with metal particles in the nanometer range makes it possible, for example, with the aid of inkjet technology, to print narrow, electrically conductive tracks having virtually any geometries. Here too, however, the metal-containing molecules have to be converted to the metal, for example by decomposition and subsequent sintering, which restricts the choice of substrates. Thus, in the case of flexible polymer substrates, the sinter temperature is a critical method parameter.

Silver carboxylate formulations in paste form for production of conductive structures are disclosed in WO 2008/038976. This patent application relates to an organic silver complex in which an organic ligand comprising an amino group and a hydroxyl group is bound to an aliphatic silver carboxylate having an equivalence ratio of 2:1. Likewise disclosed is a conductive paste comprising a silver source composed of silver oxide powder, silver powder and silver flakes, and also an organic silver complex in which an organic ligand having an amino group and a hydroxyl group is bound to the organic silver complex. The organic silver complex has a high solubility in solvents and is in the liquid state at room temperature. Therefore, in a conductive paste comprising this complex, an additional solvent need not be present or need be present only in small amounts. As a result, it is possible to increase the silver content. Furthermore, the conductive paste comprising the complex has a high viscosity and a high stability without additional dispersant, and can at the same time be used industrially in a simple manner. However, this conductive paste cannot be used to build up structures by means of inkjet printing methods, and so it is necessary to resort to screen printing methods.

Documents WO-2003/038002 and US-A-2005/0078158 describe formulations comprising silver nanoparticles which are stabilized, inter alia, with carboxymethyl cellulose sodium salt. These documents describe the necessity of aftertreatment, for example by means of heat or flocculating agents, but describe neither processing temperatures nor the conductivity of the microstructures obtained from the formulation. The contents of silver particles in the formulations disclosed are not more than 1.2% by weight. It is stated that, when the silver content is increased, the particle size rises and precipitation of the silver particles occurs within hours. It is likewise said that the formulation would not be suitable for inkjet printing merely as a result of the significant increase in viscosity of the resulting formulation.

Patent specification U.S. Pat. No. 7,615,111 B2 describes a water-based silver nanoparticle pigment which is combined with a vehicle and with at least one further dye or pigment to give an ink composition. The further dye and the silver nanoparticle pigment may, before combination thereof to give the ink composition, also each be mixed with a separate vehicle. The ink compositions of U.S. Pat. No. 7,615,111 B2 are said to be suitable for inkjet printing and for production of electrically conductive or metallically shiny coatings on substrates.

There is still a need for printable ink formulations for production of conductive structures, which are suitable especially for inkjet printing (inkjet technology). In addition, an object which is to be achieved in accordance with the invention is that the ink formulation, even in the case of low aftertreatment temperatures and a very short heat treatment, should develop electrical conductivity, such that the production of electrically conductive structures is possible even on substrates made from thermally sensitive materials, for example on plastics substrates such as polycarbonate substrates. Furthermore, it is desirable that these ink formulations can be stored stably over a prolonged period and hence, more particularly, are still suitable for inkjet printing even after the storage. It is also an alternative object of the invention to enable the production of flexible electrically conductive structures on flexible substrates.

The invention provides a silver-containing aqueous ink formulation for production of electrically conductive structures, wherein the ink formulation is provided in the form of a one- or two-component system composed of
a vehicle component A at least comprising an organic solvent, additives and water and
a silver nanoparticle sol as component B, at least comprising a liquid dispersant and electrostatically stabilized silver nanoparticles,
   and the ink formulation composed of components A and B comprises at least
a) 1-50% by weight of organic solvent,
b) 0.005-12% by weight of additives, and
c) 40-70% by weight of water,
   and
d) 15-50% by weight of electrostatically stabilized silver nanoparticles,
   where the sum of the total proportions in the ink formulation adds up to 100% by weight in each case.

The ink formulation composed of components A and B preferably comprises at least
a) 1-50% by weight of organic solvent,
b-1) 0.1-1.5% by weight of nonionic surfactant,
b-2) 0.005-2.0% by weight of ionic surfactant,
b-3) 0.01-2.0% by weight of binder,
b-4) 0.05-2.0% by weight of wetting agent,
b-5) 0.0-3.0% by weight of further ink additives, and
c) 40-70% by weight of water,
   and
d) 15-50% by weight of electrostatically stabilized silver nanoparticles, where the sum of the total proportions in the ink formulation adds up to 100% by weight in each case.

The ink formulation composed of components A and B more preferably comprises at least
a) 10-50% by weight of organic solvent,
b-1) 0.1-1.5% by weight of nonionic surfactant,
b-2) 0.005-2.0% by weight of ionic surfactant,
b-3) 0.01-2.0% by weight of binder,
b-4) 0.05-2.0% by weight of wetting agent,
b-5) 0.0-3.0% by weight of further ink additives, and
c) 40-70% by weight of water,
   and
d) 15-25% by weight of electrostatically stabilized silver nanoparticles,
   where the sum of the total proportions in the ink formulation adds up to 100% by weight in each case.

The vehicle component A is also referred to in accordance with the invention as component A, vehicle or vehicle component (ink vehicle).

According to the invention, the choice of suitable organic solvents is made particularly with regard to a low aftertreatment temperature for the ink formulation to form electrically conductive structures. In other words, suitable and preferred solvents in accordance with the invention are especially those which can be removed by a heat treatment at temperatures of about 140° C.

Suitable organic solvents preferably include mono- or polyhydric alcohols, more preferably mono- or polyhydric C₁-C₅-alcohols, for example ethanol, ethylene glycol, i-propanol, n-propanol, 1,2-propanediol, n-butanol, i-butanol, 1-pentanol, 2-pentanol, 3-pentanol and 2-methyl-1-butanol. Preferably, the organic solvent a) used in accordance with the invention is 1,2-propanediol. Preferably in accordance with the invention, the organic solvent is used in concentrations of 15-30% by weight, for example in a concentration of 20% by weight, based on the overall ink formulation.

The vehicle comprises at least one organic solvent, which, in a very particularly preferred embodiment, is 1,2-propanediol, and also additives and water.

The further ink additives b-5) for the ink formulation are preferably selected from the group of the surface-active substances, pigments, defoamers, light stabilizers, optical brighteners, corrosion inhibitors, antioxidants, algicides, plasticizers, thickeners and buffers, the enumeration being nonexhaustive.

Component B is also referred to in accordance with the invention as silver nanoparticle sol (Ag sol). According to the invention, the silver nanoparticle sol comprises at least one liquid dispersant, and silver nanoparticles stabilized with an electrostatic dispersion stabilizer, which are referred to in accordance with the invention as electrostatically stabilized silver nanoparticles or electrostatic silver nanoparticles.

The liquid dispersant(s) for the silver nanoparticle sol is/are preferably water or mixtures comprising water and organic, preferably water-soluble organic, solvents. The liquid dispersant(s) is/are more preferably water or mixtures of water with alcohols, aldehydes and/or ketones, more preferably water or mixtures of water with mono- or polyhydric alcohols having up to five, preferably having up to four, carbon atoms, for example mono- or polyhydric C₁-C₅-alcohols, for example ethanol, ethylene glycol, i-propanol, n-propanol, 1,2-propanediol, n-butanol, i-butanol, 1-pentanol, 2-pentanol, 3-pentanol and 2-methyl-1-butanol, preferably mono- or polyhydric C₁-C₅-alcohols, for example methanol, ethanol, n-propanol, isopropanol or ethylene glycol, aldehydes having up to four carbon atoms, for example formaldehyde, and/or ketones having up to four carbon atoms, for example acetone or methyl ethyl ketone. A very particularly preferred dispersant is water.

For electrostatic stabilization of the silver nanoparticles, at least one electrostatic dispersion stabilizer is added in the production of the silver nanoparticle sol. An electrostatic dispersion stabilizer in the context of the invention is understood to mean one whose presence imparts repulsive forces to the silver nanoparticles, which no longer have a tendency to aggregate on the basis of these repulsive forces. Consequently, the presence and effect of the electrostatic dispersion stabilizer results in repulsive electrostatic forces between the silver nanoparticles, which counteract the van der Waals forces which promote the aggregation of the silver nanoparticles.

The stabilization of the silver nanoparticles by means of electrostatic repulsion additionally achieves the effect that conductive structures or surface coatings can be produced on substrates in a simplified manner from the ink formulation which is advantageously stable in accordance with the invention. By the present invention, it is possible to obtain these structures and surface coatings more quickly and with lower thermal stress on the coated surface.

Silver nanoparticles in the context of the invention are understood to mean, for example, those having a d₅₀ of less than 100 nm, preferably less than 80 nm, measured by means of dynamic light scattering. An example of a suitable instrument for measurement by means of dynamic light scattering is a ZetaPlus Zeta Potential Analyzer from Brookhaven Instrument Corporation.

According to the invention, the ink formulation can be provided as a one- or two-component system. In other words, the ink formulation can advantageously first be stored separately in the form of two separately produced components A and B and subsequently combined, for example mixed, at the point of use (pou) from the two components A and B. The two inventive individual components A and B are surprisingly storage-stable over several months under suitable conditions. The ink formulation mixed together from the two individual components A and B can advantageously be stored over several days, for example a week, stably within a recommended temperature range of 5-10° C.

“Stable”, or “storage-stable”, is understood in accordance with the invention to mean that no significant agglomeration and/or precipitation of particles or significant increase in the viscosity of the ink formulation occurs. In addition, “storage-stable” means that, even after the storage time, components A and B are suitable for the production of the ink formulation, and the ink formulation produced is thus suitable for use in inkjet technology, i.e. for inkjet printing. It is thus possible in accordance with the invention, for example, to avoid problems with blocked nozzles in inkjet print heads.

In one embodiment of the invention, the dispersion stabilizer for electrostatic stabilization of the silver nanoparticles may be a di- or tricarboxylic acid having up to 5 carbon atoms or a salt thereof. The effect of choosing such an electrostatic dispersion stabilizer for the silver nanoparticles is that the inventive ink formulation requires relatively low aftertreatment temperatures and relatively short heat treatment times for formation of electrically conductive structures, for example compared to formulations using polymer-stabilized silver nanoparticle dispersions.

Particularly preferred electrostatic dispersion stabilizers for stabilization of the silver nanoparticles are citric acid or citrates, for example lithium, sodium, potassium or tetramethylammonium citrate. Very particular preference is given in accordance with the invention to using a citrate, for example lithium, sodium, potassium or tetramethylammonium citrate, as the electrostatic dispersion stabilizer. In an aqueous dispersion, the electrostatic dispersion stabilizers in salt form are present very substantially dissociated into their ions, the respective anions bringing about the electrostatic stabilization.

The aforementioned electrostatic dispersion stabilizers are also advantageous over polymers and dispersion stabilizers which provide purely steric stabilization through surface coverage, because these promote the development of the zeta potential of the silver nanoparticles in the dispersion, but at the same time result in only a negligibly small steric hindrance, if any, of the silver nanoparticles in the ink formulation produced later from the with the dispersion and in the conductive structure or surface coating obtained therefrom.

The use of citrate as an electrostatic dispersion stabilizer in the ink formulation is especially advantageous because it already melts at relatively low temperatures of about 150° C., and decomposes at temperatures above 175° C.

For a further improvement in the conductive structures or surface coatings obtained from the inventive ink formulations, it may be desirable to very substantially remove not just the dispersant and solvent but also the electrostatic dispersion stabilizer, because this has reduced conductivity compared to the silver nanoparticles and hence could possibly slightly impair the specific conductivity of the resulting structure or coating. Because of the aforementioned properties of citrate, this can be achieved in a simple manner by heating.

In a further embodiment of the inventive ink formulation, it is envisaged that the at least one nonionic surfactant b-1) is selected from the group of the alkylphenyl polyethylene oxides (available from Rohm & Haas Co.), polyethylene oxide block copolymers, acetylenic polyethylene oxides, polyethylene oxide (POE) esters; polyethylene oxide diesters; polyethylene oxide amines; polyethylene oxide amides and dimethicone copolyols. Particular preference is given to acetylenic polyethylene oxides, for example Surfynol® SEF, which are obtainable from Air Products. The nonionic surfactant(s) is/are used especially to adjust the surface tension of the inventive ink formulation to a suitable range.

In another configuration of the inventive ink formulation, the at least one ionic surfactant b-2) may preferably be selected from sulfonate-based surfactants, phosphonate-based surfactants and carboxylates. More preferably, however, the ionic surfactant b-2) is selected in accordance with the invention from the group of the sulfonate-based surfactants, for example sodium 1,2-bis(2-ethylhexyloxycarbonyl)-1-ethanesulfonate (AOT), alkyl-disulfonated diphenyl oxide disodium salts, for example mono- and dialkyl-disulfonated diphenyl oxide disodium salt, commercially available as Dowfax™ 2A1 (The Dow Chemical Company), alkyl diphenyl oxide disulfonate (commercially available as Dowfax™ 8390, The Dow Chemical Company), Polyfox™ 136A, Polyfox™ 156 (from Omnova) or anionic fluorosurfactants, for example Zonyl® FS 62 (from duPont de Nemour).

Anionic fluorosurfactants, for example Zonyl® FS 62, are found to be particularly favorable even over the desired long storage time of the ink formulation and to be compatible in interaction with the electrostatically stabilized silver nanoparticles used in accordance with the invention.

Sulfonate-based surfactants, for example Polyfox™ 136A, Polyfox™ 156 (from Omnova), or anionic fluorosurfactants, for example Zonyl® FS 62 (from duPont), can advantageously also serve as and be used as flow agents or leveling agents in the inventive ink formulation.

Sulfonate-based surfactants, preferably alkyl-disulfonated diphenyl oxide disodium salts or alkyl diphenyl oxide disulfonates, for example Dowfax™ 2A1 or Dowfax™ 8390, when used together with nonionic surfactants, show advantageous synergistic effects with regard to the properties of the resulting ink formulation, especially with regard to droplet formation and droplet shape, droplet expulsion, and avoidance or reduction of puddle formation.

It is also possible in accordance with the invention to use phosphonate-based surfactants, for example Zonyl® FSP, or carboxylates, for example Zonyl® FSA, or N-alkylsarcosinates as ionic surfactants, preference being given to the sulfonate-based surfactants over these, as already explained above.

Useful binders b-3) preferably include polyvinylpyrrolidone or block copolyethers and block copolyethers having polystyrene blocks. In a preferred configuration of the inventive ink formulation, the binder b-3) is a polyvinylpyrrolidone (PVP). The PVP is commercially available, for example as PVP-K15 from BASF. The binder can be used in the inventive ink formulation, for example, in an amount of 0.01-1.5% by weight, preferably of 0.05-1.0% by weight, for example 0.15% by weight.

In another embodiment of the invention, the at least one wetting agent e) may be a nonionic surfactant, for example a polyethylene oxide block copolymer, for example Pluronic® PE 10400 from BASF. The wetting agent can be used in the ink formulation preferably in an amount of 0.05-1.5% by weight, preferably of 0.1-1.0% by weight, for example in an amount of 0.12% by weight.

The inventive ink formulation exhibits excellent wetting of a wide variety of different substrate surfaces and can therefore be applied to a multitude of substrates, for example to plastics substrates such as polycarbonate (e.g. Makrofol® DE-1), polyvinyl chloride (PVC), or polyesters, for example PET, PETG, PBT, PBTG or PEN, including soiled and low-energy surfaces.

In a further embodiment of the inventive ink formulation, the amount of water used with preference as solvent is 50-65% by weight, for example 55-62% by weight, based on the total amount of ink formulation. Preference is given in accordance with the invention to water as solvent, since it is inexpensive, noncombustible and harmless to health.

It is also possible in accordance with the invention, although less preferred, that the solvent is selected from the group comprising ethanol, acetonitrile, tetrahydrofuran, dioxane, dimethyl sulfoxide, aromatic amines, monoalkylamines, dialkylamines, trialkylamines, monoalkanolamines, dialkanolamines and/or trialkanolamines, and mixtures of these solvents with water. The aforementioned solvents have a comparatively low vapor pressure, such that blockage of the nozzle of an inkjet print head by substance residues after the vaporization of the solvent is rare and/or can be remedied quickly by suitable purge cycles.

In a further embodiment of the invention, the surface tension of the ink formulation may be ≧20 mN/m to ≦70 mN/m. The surface tension may be determined by the hanging drop method. A suitable instrument for this purpose is what is called a tensiometer from Krüss, model K100. It is possible that the surface tension of the ink formulation is, for example, within a range from ≧25 mN/m to ≦35 mN/m or from ≧26 mN/m to ≦33 mN/m, for example in a range from ≧29 mN/m to ≦31 mN/m. Inks having such surface tensions can be processed efficiently in inkjet printers. In addition, it is possible with such inks to reproduce even small structures efficiently on polar substrates such as glass, polyimide or polyethylene terephthalate. The surface tension can be adjusted, for example, via the choice and concentration of the nonionic surfactant in the ink formulation.

In a further embodiment, the viscosity of the inventive ink formulation may be ≧1 mPa s to ≦100 mPa s, preferably to ≦20 mPa s. The viscosity can be determined on the basis of standard DIN 51562 Part 1 or with a conventional rotary viscometer at a selected shear rate. For example, the viscosity may be within a range from ≧1.5 mPa s to ≦10 mPa s or from ≧2.0 mPa s to ≦6 mPa s. It is also possible in accordance with the invention that the viscosity is, for example, within a range from ≧3 mPa s to ≦4 mPa s. Inks having such viscosities can be processed efficiently in inkjet printers.

With regard to further features of an inventive ink formulation, reference is hereby made explicitly to the details given in connection with the process according to the invention and the inventive use.

The invention further relates to a process for producing the inventive ink formulation, in which the two components
vehicle component A at least comprising an organic solvent, additives and water and
a silver nanoparticle sol as component B, at least comprising a liquid dispersant and electrostatically stabilized silver nanoparticles,
   are produced separately and then combined, such that the ink formulation thus obtained comprises at least
a) 1-50% by weight of organic solvent,
b) 0.005-12% by weight of additives, and
c) 40-70% by weight of water,
   and
d) 15-50% by weight of electrostatically stabilized silver nanoparticles,
   where the sum of the total proportions in the ink formulation adds up to 100% by weight in each case.

Component B (silver nanoparticle sol) comprises the electrostatically stabilized silver nanoparticles preferably in an amount of 15 to 65% by weight, more preferably of 18 to 55% by weight, most preferably of 20 to 50% by weight, based on the total weight of component B.

The electrostatic dispersion stabilizer is present in component B (silver nanoparticle sol) preferably in an amount of 0.5 to 5% by weight, more preferably in an amount of 1 to 3% by weight, based on the weight of the silver in the silver nanoparticles in component B.

The silver nanoparticle sol can be produced, for example, by reducing a silver salt in a liquid dispersant in the presence of an electrostatic dispersion stabilizer, and any subsequent purification and concentration steps. Suitable reducing agents here are preferably thioureas, hydroxyacetone, borohydrides, iron ammonium citrate, hydroquinone, ascorbic acid, dithionites, hydroxymethanesulfinic acid, disulfites, formamidinesulfinic acid, sulfurous acid, hydrazine, hydroxylamine, ethylenediamine, tetramethylethylenediamine and/or hydroxylamine sulfates. Particularly preferred reducing agents are borohydrides. A very particularly preferred reducing agent is sodium borohydride. Suitable silver salts are, for example and with preference, silver nitrate, silver acetate, silver citrate. Particular preference is given to silver nitrate.

Component A) can be produced, for example, by simply mixing the individual components: organic solvent, additives and water.

With regard to further features of the process according to the invention for producing the inventive ink formulation, reference is hereby made explicitly to the details given in connection with the inventive ink formulation and the use thereof.

This process of the inventive ink formulation offers the advantage of better storage stability, since the inventive ink formulation can advantageously first be stored separately in the form of two separately produced components A and B and subsequently combined, for example mixed, at the point of use (pou) from the two components A and B. The two inventive individual components A and B are surprisingly storage-stable under suitable conditions over several months.

The invention further relates to a process for producing electrically conductive structures and/or coatings on a substrate—referred to hereinafter as process according to the invention—comprising the steps of
A) providing a substrate,
B) applying the ink formulation as claimed in any of claims 1 to 9, especially by means of printing, preferably by means of inkjet printing, to at least one surface of the substrate,
C) drying the ink formulation and heat-treating the printed substrate.

Electrically conductive structures and/or coatings in this context are especially structures and surface coatings having a conductivity of more than 1·10⁶ S/m. More particularly, it is even possible to achieve an electrical conductivity of the printed, dried and heat-treated ink formulation better than 5·10⁶ S/m, for example of 7·10⁶ S/m.

The substrate provided under A) may, in accordance with the invention, be a substrate composed of a material which is an electrical insulator or has poor conductivity, especially also a flexible material. For example, this may be an article made from glass or plastic, for example a glass pane or a polymer film.

Examples of useful plastics for such a substrate include thermoplastics. These may be, for example, polycarbonates or copolycarbonates based on diphenols, poly- or copolyacrylates and poly- or copolymethacrylates, for example and with preference polymethyl methacrylate, poly- or copolymers with styrene, for example and with preference transparent polystyrene or polystyrene-acrylonitrile (SAN), thermoplastic polyurethanes, and polyolefins, for example and with preference polypropylene types, polyvinyl chloride types or polyolefins based on cyclic olefins (e.g. TOPAS®, Hoechst), poly- or copolycondensates of terephthalic acid, for example and with preference poly- or copolyethylene terephthalate (PET or CoPET), glycol-modified PET (PETG) or poly- or copolybutylene terephthalate (PBT or CoPBT), polyimides, polyamides or mixtures of the aforementioned.

The application of the inventive ink formulation in step B) can be effected especially by means of a printing method, preferably by means of inkjet printing, in structured form or in the form of a full-area application. Suitable inkjet printing processes include, for example, thermal inkjet printing, piezoelectric inkjet printing or continuous and drop-on-demand (DOD) inkjet printing.

The drying of the ink formulation and the heat treatment in step C) can advantageously be effected in one step and especially in the form of a sintering operation at favorable, mild temperatures with escape of the solvents. Step C) may, in accordance with the invention, also include photonic low-temperature sintering and/or be effected with microwave or laser assistance.

In another embodiment of the process, the substrate preferably comprises a material which is selected from the group comprising glass, polyimide, polycarbonate, polyester, PVC and/or polyamide, more preferably glass, polyimide (PI), polycarbonate (PC) and/or polyethylene terephthalate (PET). These materials can be printed efficiently and can easily be functionalized further, the enumeration of the suitable materials being nonexhaustive.

In one embodiment of the process according to the invention, the heat treatment can be effected at at least one temperature of more than 40° C., preferably within a temperature range from 80° C. to 180° C., most preferably within a range from 120° C. to 160° C., for example at 130° C. or 140° C. The selected temperature or the selected temperature ranges can advantageously be kept below and matched to the softening point of the substrate material used. Advantageously, it is possible thereby to use the process according to the invention also for the production of electrically conductive structures on thermally sensitive substrates, for example polycarbonate films.

According to the invention, it is advantageously possible, even given the low thermal stress during the heat treatment in step C), to obtain electrically conductive structures and coatings with very good adhesion on substrates such as glass carriers, but also polymer films, for example polycarbonate films.

In a further embodiment of the process according to the invention, it is possible to conduct the heat treatment in step C) over a period of 5 minutes up to one day, preferably over a period of 5 minutes up to one hour, more preferably over a period of 7 minutes to 20 minutes, for example over a period of 10 minutes or 15 minutes. Especially for the production of flexible electrically conductive structures and coatings, the short heat treatment times envisaged in accordance with the invention in step C) are advantageous.

With regard to further features of a process according to the invention, reference is hereby made explicitly to the details given in connection with the inventive ink formulation and the use thereof.

The invention further relates to an electrically conductive structure and/or coating on a substrate, obtainable from an inventive ink formulation as described above, especially by means of a printing method. It is possible here to use the various embodiments of the ink formulation individually or in combination with one another for production of the electrically conductive structure and/or coating.

Advantageously, the electrically conductive structures or coatings formed from the inventive ink formulation, for example conductor tracks, may be mechanically flexible, such that they retain conductivity even in the event of expansion of the substrate material. More particularly, the electrically conductive structures or coatings may also have particularly good adhesion on the standard substrates, for example on polycarbonate.

The invention also relates to the use of an inventive ink formulation as an ink for inkjet printers and/or for production of electrically conductive structures and/or electrically conductive coatings on substrates. More particularly, it is also possible to coat flexible substrates with the ink formulation according to the invention. With regard to further features and advantages of an inventive use, reference is made explicitly to the above-described ink formulation and to the process according to the invention.

The invention further provides electrically conductive structures and/or coatings on a substrate, obtainable from an inventive ink formulation, especially by means of a printing method, preferably by means of inkjet printing. Such electrically conductive structures may, for example, be conductor tracks, antenna elements, sensor elements or bonding connections for contacting with semiconductor components. Also conceivable in accordance with the invention is the use of the inventive ink formulation in flexographic printing or in aerosol jet printing.

The invention further provides electrically conductive structures and/or coatings, especially obtained by a process according to the present invention, especially by means of the inventive ink formulation.

The process according to the invention can advantageously also be used for production of flexible, electrically conductive structures which retain their conductivity even in the event of expansion or bending of the substrate, and can additionally exhibit good adhesion on the substrate.

In a further embodiment of the process, in the course of inkjet printing, droplet formation is preferably achieved in a piezoelectrically driven print head. This involves, with the aid of the piezoelectric effect, generating a sound wave in the ink volume in the pressure nozzle through the walls of the ink nozzle, which causes the expulsion of an ink droplet in the direction of the print substrate at the orifice of the nozzle. With regard to the thermal stability of the functional inks, the advantage of the piezo heads lies in the comparatively mild interaction with the inks.

Influencing parameters on the droplet formation in piezo technology are the speed of sound in the ink itself, the interfacial tensions between the materials involved and the viscosity of the ink. Furthermore, through the control voltage (waveform) applied to the piezo crystal over time, it is possible to influence the droplet size, speed and shape, and hence the print quality. The aim is a spherical droplet shape without satellite droplets. The droplet size and droplet speed, together with the relative movement of the print head with respect to the substrate, determine the resolution, edge sharpness and print speed of the printing system.

The properties described make the piezo inkjet method particularly suitable for the printing of inks, with the aid of which it is possible to produce functional layers structured in the manner of an image on a wide variety of different substrates.

There is a range of possible variations in the choice of ink constituents and in the optimization of the droplet formation. Thus, piezo technology permits a wide range of functional materials for controlled structured deposition.

In a further embodiment of the process, the piezoelectrically driven print head is operated with a drive voltage of ≧1 V to ≦40 V and a pulsewidth of ≧1 μs to ≦20 μs. The drive voltage may also be within a range from ≧10 V to ≦20 V or from ≧14 V to ≦18 V. The pulsewidth may also be within a range from ≧3 μs to ≦10 μs or from ≦6 μs to ≦7 μs.

The present invention is illustrated further hereinafter by the working examples and with reference to the drawings, without being restricted thereto. The figures show:

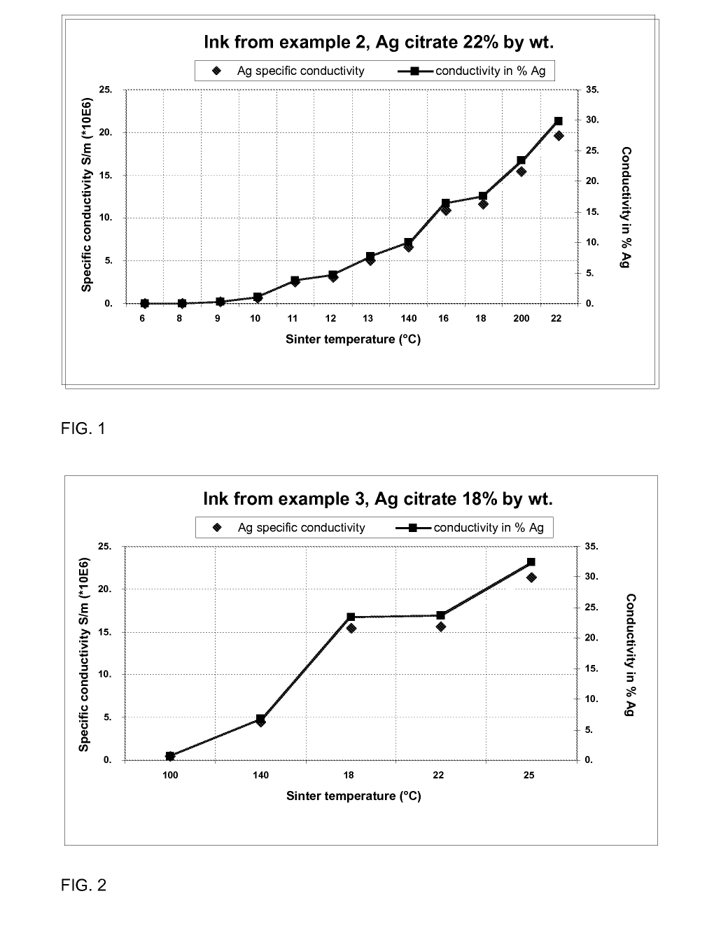

FIG. 1 in a diagram, the dependence of the conductivity of a coating obtainable from the inkjet formulation according to example 2 on the sinter temperature with a heat treatment time of 10 minutes and

FIG. 2 in a diagram, the dependence of the conductivity of a coating obtainable from the inkjet formulation according to example 3 on the sinter temperature with a heat treatment time of 15 minutes.

### EXAMPLES

### Example 1

### Preparation of the Silver Nanoparticle Sol (Ag Sol; Component B)

a) A flask of capacity 2 l was initially charged with 1 l of distilled water. Subsequently, 100 ml of a 0.7% by weight trisodium citrate solution and, thereafter, 200 ml of a 0.2% by weight sodium borohydride solution were added while stirring. A 0.045 molar silver nitrate solution was gradually metered at a volume flow rate of 0.2 l/h into the mixture obtained while stirring over a period of one hour. In the course of this, the inventive dispersion formed (Ag sol), which was subsequently purified by diafiltration and concentrated to solids content 32.0% by weight of citrate-stabilized silver nanoparticles, based on the total weight of the dispersion.

b) The production of the silver nanoparticle sol was repeated, except that the inventive dispersion (Ag sol) was purified by diafiltration and concentrated to solids content 32.6% by weight of citrate-stabilized silver nanoparticles, based on the total weight of the dispersion.

### Example 2

### Production of an Ink Formulation Containing 22% by Weight of Electrostatically Stabilized Silver Nanoparticles

The reactants specified in tab. 1 were mixed in the specified sequence 1-6 to give component A and stirred for 30 minutes. The reactants are commercially available, for example, as aqueous solutions under the trade names given: 1,2-propanediol and PVP 15 (Sigma Aldrich), Pluronics® PE10400 (BASF), Dowfax™ 8390 (DOW Chemical Company), Surfynol® 465 (Air Products) and were supplemented with deionized water to give component A. Component A as the vehicle was added dropwise to 12.5 g of the Ag sol (component A) from example 1a) with constant stirring. The mixture was stirred for two to three hours.

TABLE 1

| Se- | | | Conc. | Conc. in |
|---|---|---|---|---|
| quence | | Proportion | of the | the ink |
| of | | in | reactants | formulation |
| addition | Reactants | [g] | [%] | [% by weight] |
| 1 | 1,2-propanediol | 4.00 | 100.00 | 20.00 |
| 2 | Surfynol ® 465 | 0.50 | 20.00 | 0.50 |
| 3 | Dowfax ™ 8390 | 0.15 | 20.00 | 0.15 |
| 4 | PVP-K15 | 0.30 | 10.00 | 0.15 |
| 5 | Pluronic ® PE 10400 | 0.24 | 10.00 | 0.12 |
| 6 | DI water | 2.30 | | 59.10 |
| 7 | Ag sol (component B) | 12.50 | 32.00 | 22.00 |
| | | 20 | | 100 |

The ink formulation thus produced had, at 20° C., measured with a Physica MCR 301 rheometer at a shear rate of 1/s, a viscosity of 3-4 mPa s and a surface tension of 29-31 mN/m. The pH was 6.5. An adjustment of the pH, which is optionally possible in accordance with the invention, for example with aqueous KOH, NaOH or with DMEA, was therefore unnecessary. With the aforementioned characteristics, it was therefore suitable for inkjet printing.

The finished ink formulation could be stored stably at 5-10° C. for 7 days. It was possible by means of inkjet printing and subsequent sintering at 140° C. to obtain conductive structures on Makrofol DE 1-1 films and on glass substrates.

### Example 3

### Production of an Ink Formulation Containing 18% by Weight of Electrostatically Stabilized Silver Nanoparticles

First, the reactants specified in tab. 1 were mixed in the specified sequence 1-7 to give component A and stirred for 30 minutes. The reactants are commercially available, for example, as aqueous solutions under the trade names given: 1,2-propanediol and PVP K15 (Sigma Aldrich), Pluronics® PE10400 (BASF), Dowfax™ 8390 (DOW Chemical Company), Surfynol® 465 (Air Products) and were supplemented with deionized water to give a total of 20 g (component A). Component A as the vehicle was added dropwise to 12.5 g of the Ag sol (component A) from example 1b) while stirring constantly. The mixture was stirred for two to three hours.

TABLE 2

| Se- | | | Conc. | Conc. in |
|---|---|---|---|---|
| quence | | Proportion | of the | the ink |
| of | | in | reactants | formulation |
| addition | Reactants | [g] | [%] | [% by weight] |
| 1 | 1,2-propanediol | 4.00 | 100.00 | 20.00 |
| 2 | Surfynol ® 465 | 1.00 | 10.00 | 0.50 |
| 3 | Polyfox 136 A | 0.020 | 10.00 | 0.01 |
| | (approx. 30%) | | | |
| 4 | Dowfax ™ 8390 | 0.010 | 10.00 | 0.005 |
| 5 | PVP-K15 | 0.10 | 10.00 | 0.05 |
| 6 | Pluronic ® PE 10400 | 0.20 | 10.00 | 0.10 |
| 7 | DI water | 3.60 | | 61.3 |
| 8 | Ag sol (component B) | 11.03 | 32.64 | 18.00 |
| | | 20 | | 100 |

The ink formulation thus produced had, at 20° C., measured with a Physica MCR 301 rheometer at a shear rate of 1/s, a viscosity of 3-4 mPa s and a surface tension of 26-28 mN/m. The pH was 6.5. An adjustment of the pH, which is optionally possible in accordance with the invention, for example with aqueous KOH, NaOH or with DMEA, was therefore unnecessary. With the aforementioned characteristics, it was therefore suitable for inkjet printing.

The finished ink formulation could be stored stably at 5-10° C. for 7 days. It was possible by means of inkjet printing and subsequent sintering at 140° C. to obtain conductive structures on polycarbonate films (Makrofol® DE 1-1 films) and on glass substrates.

The ink formulations from examples 2 and 3 were used in a Dimatix Materials Printer DMP 2831 having a 10 μL print head. For control, a waveform tailored to this ink having a maximum voltage of 16 V and a pulsewidth of 6.5 μs was used. In the course of printing, neither the print head nor the substrate was heated.

### Example 4

In a test series, the dependence of the conductivity of the silver structures on a glass substrate on the sinter temperature was also examined with a duration of the heat treatment of 10 min in each case. The silver structures were obtainable by means of an ink formulation according to example 2 by piezoelectric inkjet printing with a Dimatrix 2831 printer. The results are shown in FIG. 1 and in tab. 3. At a sinter temperature of 140° C., after a heat treatment time of 10 minutes, a conductivity of 10 in % Ag was achieved in the coating obtained.

With the inventive ink formulation, it is therefore possible at comparatively mild sinter temperatures and with a relatively short heat treatment to obtain good conductivity values in the printed structures. High-quality structured coatings were produced, the conductivity of which is close to the specific conductivity of silver, which is especially advantageous for use in the field of flexible printed electronics.

TABLE 3

| | | Specific | |
|---|---|---|---|
| Sinter temperature | Sinter time | conductivity | Conductivity in % |
| [° C.] | [min] | [S/m (*10E6)] | Ag |
| 60 | 10 | 0.000262 | 0.00 |
| 80 | 10 | 0.000604 | 0.00 |
| 90 | 10 | 0.209597 | 0.32 |
| 100 | 10 | 0.684247 | 1.04 |
| 110 | 10 | 2.507202 | 3.80 |
| 120 | 10 | 3.062521 | 4.64 |
| 130 | 10 | 5.055523 | 7.66 |
| 140 | 10 | 6.610461 | 10.02 |
| 160 | 10 | 10.836734 | 16.42 |
| 180 | 10 | 11.591584 | 17.56 |
| 200 | 10 | 15.421245 | 23.37 |

### Example 5

In a test series, the dependence of the conductivity of the silver structures on a glass substrate on the sinter temperature was also examined with a duration of the heat treatment of 15 min. The silver structures were obtainable by means of an ink formulation according to example 3 by piezoelectric inkjet printing with a Dimatrix 2831 printer. The results are shown in FIG. 2 and in tab. 4. At a sinter temperature of 140° C., after a heat treatment time of 15 minutes, a conductivity of 6.8 in % Ag was achieved.

With this inventive ink formulation too, it is therefore possible at comparatively mild sinter temperatures and with a relatively short heat treatment to obtain good conductivity values in the printed structures. High-quality structured coatings were produced, the conductivity of which is close to the specific conductivity of silver, which is especially advantageous for use in the field of flexible printed electronics.

In the comparison with example 4, it is found that, with the ink formulation having a higher concentration of silver nanoparticles (from example 4), a better conductivity can be achieved with a shorter heat treatment time of 10 minutes. Both the better conductivity and the shorter sinter time are more favorable for the production and requirements of flexible printed electronics.

TABLE 4

| | | Specific | |
|---|---|---|---|
| Sinter temperature | Sinter time | conductivity | Conductivity in % |
| [° C.] | [min] | [S/m (*10E6)] | Ag |
| 100 | 15 | 0.449836 | 0.68 |
| 140 | 15 | 4.485007 | 6.80 |
| 180 | 15 | 15.432770 | 23.38 |
| 225 | 15 | 15.657940 | 23.72 |
| 250 | 15 | 21.367166 | 32.37 |

1. A silver-containing aqueous ink formulation for production of electrically conductive structures, which is provided in the form of a one- or two-component system composed of
a vehicle component A at least comprising an organic solvent, additives and water and
a silver nanoparticle sol as component B, at least comprising a liquid dispersant and electrostatically stabilized silver nanoparticles,
and the formulation composed of components A and B comprises at least
a) 1-50% by weight of organic solvent,
b) 0.005-12% by weight of additives, and
c) 40-70% by weight of water,
and
d) 15-50% by weight of electrostatically stabilized silver nanoparticles,
where the sum of the total proportions in the ink formulation adds up to 100% by weight in each case.

2. The ink formulation as claimed in claim 1, characterized in that the silver nanoparticles are stabilized with a di- or tricarboxylic acid having up to 5 carbon atoms or a salt thereof as an electrostatic dispersion stabilizer.

3. The ink formulation as claimed in claim 1, characterized in that citric acid or a citrate is used for electrostatic stabilization of the silver nanoparticles.

4. The ink formulation as claimed in claim 1, characterized in that it comprises at least one nonionic surfactant as an additive and the at least one nonionic surfactant is selected from alkylphenyl polyethylene oxides, polyethylene oxide block copolymers, acetylenic polyethylene oxides, polyethylene oxide esters, polyethylene oxide diesters, polyethylene oxide amines, polyethylene oxide amides and dimethicone copolyols.

5. The ink formulation as claimed in claim 1, characterized in that it comprises at least one ionic surfactant as an additive and the at least one ionic surfactant is selected from sulfonate-based surfactants, phosphonate-based surfactants and carboxylates.

6. The ink formulation as claimed in claim 1, characterized in that it comprises at least one binder and the binder is polyvinylpyrrolidone (PVP).

7. The ink formulation as claimed in claim 1, characterized in that it comprises at least one wetting agent and the at least one wetting agent is a nonionic surfactant.

8. The ink formulation as claimed in claim 1, characterized in that the surface tension of the ink formulation is ≧20 mN/m to ≦70 mN/m.

9. The ink formulation as claimed in claim 1, characterized in that the viscosity of the formulation is within a range between ≧1 mPa s and ≦100 mPa s.

10. A process for producing the ink formulation as claimed in claim 1, characterized in that the two components
vehicle component A at least comprising an organic solvent, additives and water and
a silver nanoparticle sol as component B, at least comprising a liquid dispersant and electrostatically stabilized silver nanoparticles,
are produced separately and then combined, such that the ink formulation thus obtained comprises at least
a) 1-50% by weight of organic solvent,
b) 0.005-12% by weight of additives, and
c) 40-70% by weight of water,
and
d) 15-50% by weight of electrostatically stabilized silver nanoparticles,
where the sum of the total proportions in the ink formulation adds up to 100% by weight in each case.

11. A process for producing electrically conductive structures and/or coatings on a substrate, characterized by the steps of
A) providing a substrate,
B) applying the ink formulation as claimed in claim 1 by means of printing to at least one surface of the substrate,
C) heat-treating the printed substrate.

12. The process as claimed in claim 11, characterized in that the heat treatment is performed at at least one temperature within a temperature range of 40° C. to 180° C.

13. The process as claimed in claim 11, characterized in that the heat treatment is performed over a period of 5 minutes to 1 hour.

14. An electrically conductive structure comprising a substrate having a surface coated with an ink formulation as claimed in claim 1.

15. The ink formulation as claimed in claim 1 wherein the ink formulation is an ink for an inkjet printer.

16. An electrically conductive structure as claimed in claim 14, wherein the ink formulation is printed on the substrate surface.

17. A process as claimed in claim 11, wherein the ink formulation is applied by inkjet printing.
